(19) United States
(12) Patent Application Publication
(10) Pub. No.: US 2015/0097766 A1
(43) Pub. Date: Apr. 9, 2015

(54) ZOOMING WITH AIR GESTURES

(71) Applicant: Microsoft Corporation, Redmond, WA (US)

(72) Inventors: Jay Kapur, Redmond, WA (US); Mark Schwesinger, Bellevue, WA (US); Emily Yang, Seattle, WA (US); Sergio Paolantonio, Seattle, WA (US); Federico Schliemann, Redmond, WA (US); Christian Klein, Duvall, WA (US)

(73) Assignee: Microsoft Corporation, Redmond, WA (US)

(21) Appl. No.: 14/046,693

(22) Filed: Oct. 4, 2013

(51) Int. Cl. G06F 3/01

(52) U.S. Cl. CPC G06F 3/017
USPC 345/156

(57) ABSTRACT

An NUI system for mediating input from a computer-system user. The NUI system includes a logic machine and an instruction storage machine. The instruction-storage machine holds instructions that cause the logic machine to receive data tracking a change in conformation of the user including at least a hand trajectory of the user. If the data show increasing separation between two hands of the user, the NUI system causes a foreground process of the computer system to be displayed in greater detail on the display. If the data show decreasing separation between the two hands of the user, the NUI system causes the foreground process to be represented in lesser detail.

### BACKGROUND

Natural user-input (NUI) technologies aim to provide intuitive modes of interaction between computer systems and human beings. Such modes may include gesture and/or voice recognition, for example. Increasingly, a suitably configured vision and/or listening system may replace or supplement traditional user-interface hardware such as a keyboard, mouse, touch-screen, gamepad, or joystick controller, in various computer systems.

### SUMMARY

One embodiment of this disclosure provides an NUI system for mediating input from a computer-system user. The NUI system includes a logic machine and an instruction storage machine. The instruction-storage machine holds instructions that cause the logic machine to receive data tracking a change in conformation of the user, including at least a hand trajectory of the user. If the data show increasing separation between two hands of the user, the NUI system causes a foreground process of the computer system to be displayed in greater detail on the display. If the data show decreasing separation between the two hands of the user, the NUI system causes the foreground process to be represented in lesser detail.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example environment in which NUI is used to control a computer system, in accordance with an embodiment of this disclosure.

FIG. 2 shows aspects of a computer system and an NUI system in accordance with an embodiment of this disclosure.

FIG. 3 illustrates an example method for mediating NUI in a computer system in accordance with an embodiment of this disclosure.

FIG. 4 shows aspects of an example virtual skeleton in accordance with an embodiment of this disclosure.

FIG. 5 shows an example posture in which a user's hands are presented in front of the user in accordance with an embodiment of this disclosure.

FIGS. 6A and 6B illustrate example frames of a display that show a first visual guide in accordance with embodiments of this disclosure.

FIG. 7 shows an example posture in which a user's hands are closed to enact an air grab of a display in accordance with an embodiment of this disclosure.

FIGS. 8A and 8B illustrate example frames of a display that show a second visual guide in accordance with embodiments of this disclosure.

FIG. 9 shows an example gesture in which a user has increased the separation of his or her closed hands in accordance with an embodiment of this disclosure.

FIG. 10 shows an example display in which a foreground process is displayed full-screen in accordance with an embodiment of this disclosure.

FIG. 11 shows an example gesture in which a user has decreased the separation of his or her closed hands in accordance with an embodiment of this disclosure.

FIG. 12 shows an example display in which a foreground process is displayed in a window in accordance with an embodiment of this disclosure.

FIG. 13 shows a two-handed rotation gesture in accordance with an embodiment of this disclosure.

FIG. 14 shows a two-handed sweep gesture in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

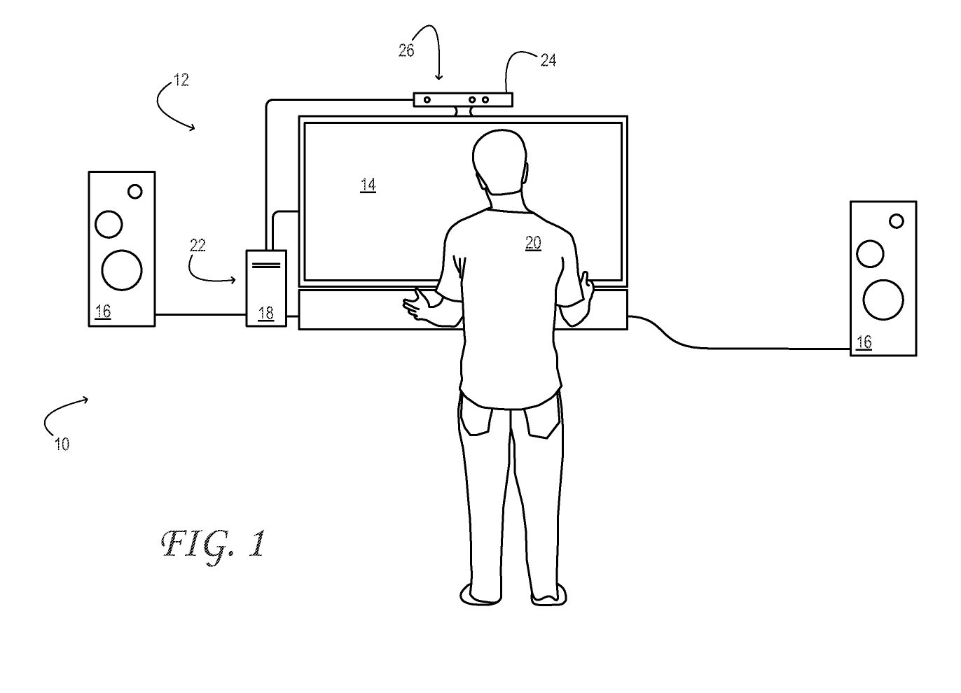

FIG. 1 shows aspects of an example environment 10. The illustrated environment is a living room or family room of a personal residence. However, the approaches described herein are equally applicable in other environments, such as retail stores and kiosks, restaurants, information and public-service kiosks, etc.

The environment of FIG. 1 features a home-entertainment system 12. The home-entertainment system includes a large-format display 14 and loudspeakers 16, both operatively coupled to computer system 18. In other embodiments, such as near-eye display variants, the display may be installed in headwear or eyewear worn by a user of the computer system.

In some embodiments, computer system 18 may be a video-game system. In some embodiments, computer system 18 may be a multimedia system configured to play music and/or video. In some embodiments, computer system 18 may be a general-purpose computer system used for internet browsing and productivity applications—word processing and spreadsheet applications, for example. In general, computer system 18 may be configured for any or all of the above purposes, among others, without departing from the scope of this disclosure.

Computer system 18 is configured to accept various forms of user input from one or more users 20. As such, traditional user-input devices such as a keyboard, mouse, touch-screen, gamepad, or joystick controller (not shown in the drawings) may be operatively coupled to the computer system. Regardless of whether traditional user-input modalities are supported, computer system 18 is also configured to accept so-called natural user input (NUI) from at least one user. In the scenario represented in FIG. 1, user 20 is shown in a standing position; in other scenarios, a user may be seated or lying down, again without departing from the scope of this disclosure.

To mediate NUI from the one or more users, NUI system 22 is operatively coupled within computer system 18. The NUI system is configured to capture various aspects of the NUI and provide corresponding actionable input to the computer system. To this end, the NUI system receives low-level input from peripheral sensory components, which include vision system 24 and listening system 26. In the illustrated embodiment, the vision system and listening system share a common enclosure; in other embodiments, they may be separate components. In still other embodiments, the vision, listening and NUI systems may be integrated within the computer system. The computer system and the vision system may be coupled via a wired communications link, as shown in the drawing, or in any other suitable manner. Although FIG. 1 shows the sensory components arranged atop display 14, various other arrangements are contemplated as well. The NUI system could be mounted on a ceiling, for example.

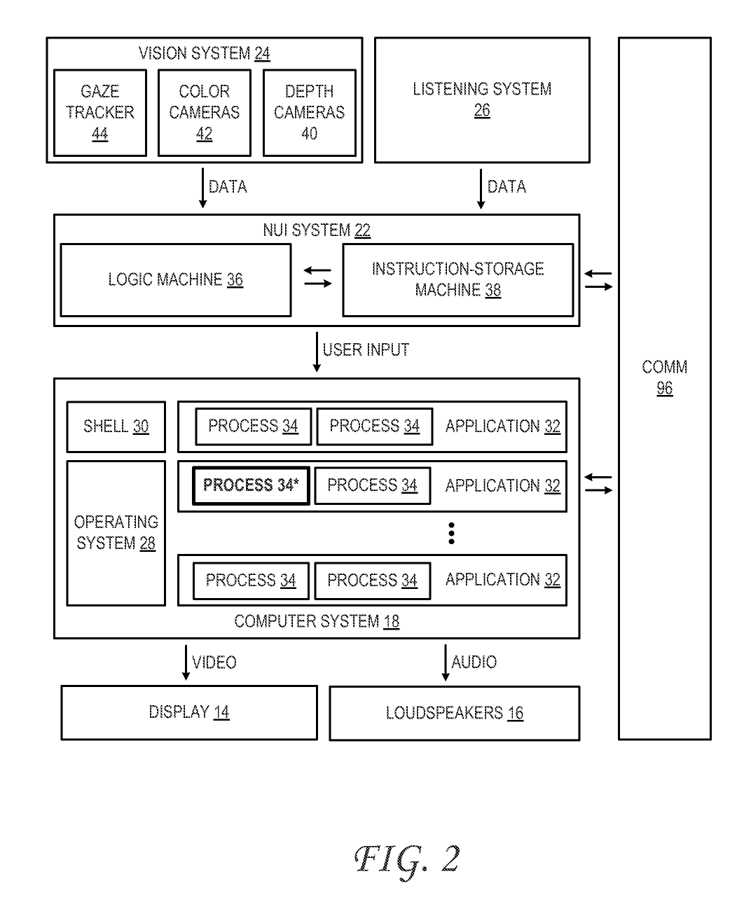

FIG. 2 is a high-level schematic diagram showing aspects of computer system 18, NUI system 22, vision system 24, and listening system 26, in one example embodiment. The illustrated computer system includes operating system (OS) 28, which may be instantiated in software and/or firmware. The computer system also includes an OS shell 30 and one or more applications 32, such as a video-game application, a digital-media player, an internet browser, a photo editor, a word processor, and/or a spreadsheet application, for example. With each application may be associated one or more processes 34; at least one process is instantiated in the data structures of the computer system when an application is executed. Typically, one process is designated as the foreground process—viz., 34* in FIG. 2. As used herein, a ‘foreground process’ is the active process when only one process is active on the computer system. In multi-tasking scenarios in which more than one process may be active, the foreground process is the process that has current input focus on the computer system. Naturally, the computer system may also include suitable data-storage, instruction-storage, and logic hardware, as needed to support the OS, OS shell, applications, and processes.

As noted above, NUI system 22 is configured to provide user input to computer system 18. To this end, the NUI system includes a logic machine 36 and an instruction-storage machine 38. To detect NUI, the NUI system receives low-level input (i.e., signal) from various sensory components—e.g., vision system 24 and listening system 26.

Listening system 26 may include one or more microphones to pick up audible input from one or more users or other sources in environment 10. The vision system, meanwhile, detects visual input from the users. In the illustrated embodiment, the vision system includes one or more depth cameras 40, one or more color cameras 42, and a gaze tracker 44. The NUI system processes low-level input from these sensory components to provide actionable, high-level input to computer system 18. For example, the NUI system may perform sound- or voice-recognition on audio signal from listening system 26. Such recognition may generate corresponding text-based or other high-level commands, which are received in computer system 18.

Continuing in FIG. 2, each depth camera 40 may comprise an imaging system configured to acquire a time-resolved sequence of depth maps of one or more human subjects that it sights. As used herein, the term ‘depth map’ refers to an array of pixels registered to corresponding regions (Xᵢ, Yᵢ) of an imaged scene, with a depth value Zᵢ indicating, for each pixel, the depth of the corresponding region. ‘Depth’ is defined as a coordinate parallel to the optical axis of the depth camera, which increases with increasing distance from the depth camera. Operationally, a depth camera may be configured to acquire two-dimensional image data from which a depth map is obtained via downstream processing.

In general, the nature of depth cameras 40 may differ in the various embodiments of this disclosure. For example, a depth camera can be stationary, moving, or movable. Any non-stationary depth camera may have the ability to image an environment from a range of perspectives. In one embodiment, brightness or color data from two, stereoscopically oriented imaging arrays in a depth camera may be co-registered and used to construct a depth map. In other embodiments, a depth camera may be configured to project onto the subject a structured infrared (IR) illumination pattern comprising numerous discrete features—e.g., lines or dots. An imaging array in the depth camera may be configured to image the structured illumination reflected back from the subject. Based on the spacings between adjacent features in the various regions of the imaged subject, a depth map of the subject may be constructed. In still other embodiments, the depth camera may project a pulsed infrared illumination towards the subject. A pair of imaging arrays in the depth camera may be configured to detect the pulsed illumination reflected back from the subject. Both arrays may include an electronic shutter synchronized to the pulsed illumination, but the integration times for the arrays may differ, such that a pixel-resolved time-of-flight of the pulsed illumination, from the illumination source to the subject and then to the arrays, is discernible based on the relative amounts of light received in corresponding elements of the two arrays. Depth cameras 40, as described above, are naturally applicable to observing people. This is due in part to their ability to resolve a contour of a human subject even if that subject is moving, and even if the motion of the subject (or any part of the subject) is parallel to the optical axis of the camera. This ability is supported, amplified, and extended through the dedicated logic architecture of NUI system 22.

When included, each color camera 42 may image visible light from the observed scene in a plurality of channels—e.g., red, green, blue, etc.—mapping the imaged light to an array of pixels. Alternatively, a monochromatic camera may be included, which images the light in grayscale. Color or brightness values for all of the pixels exposed in the camera constitute collectively a digital color image. In one embodiment, the depth and color cameras used in environment 10 may have the same resolutions. Even when the resolutions differ, the pixels of the color camera may be registered to those of the depth camera. In this way, both color and depth information may be assessed for each portion of an observed scene.

It will be noted that the sensory data acquired through NUI system 22 may take the form of any suitable data structure, including one or more matrices that include X, Y, Z coordinates for every pixel imaged by the depth camera, and red, green, and blue channel values for every pixel imaged by color camera, in addition to time resolved digital audio data from listening system 26.

The configurations described above enable various methods for providing NUI to a computer system. Some such methods are now described, by way of example, with continued reference to the above configurations. It will be understood, however, that the methods here described, and others within the scope of this disclosure, may be enabled by different configurations as well. The methods herein, which involve the observation of people in their daily lives, may and should be enacted with utmost respect for personal privacy. Accordingly, the methods presented herein are fully compatible with opt-in participation of the persons being observed. In embodiments where personal data is collected on a local system and transmitted to a remote system for processing, that data can be anonymized. In other embodiments, personal data may be confined to a local system, and only non-personal, summary data transmitted to a remote system.

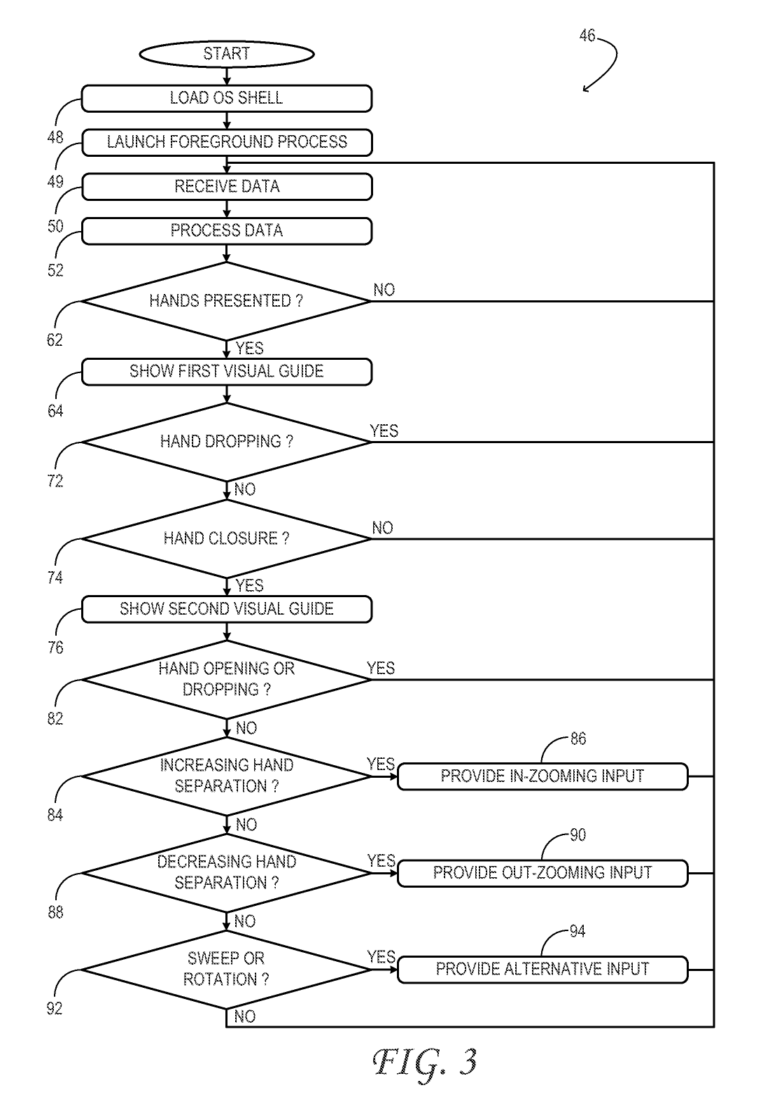

FIG. 3 illustrates an example method 46 for providing NUI in a computer system, such as computer system 18. As will be clear from the following description, certain aspects of the method are to be enacted in the computer system that receives the NUI, while other aspects are enacted in the NUI system that provides the input. At 48 of method 46, an operating-system (OS) shell 30 of the computer system is loaded and executed. From the OS shell, one or more applications 32 may be launched by the user, resulting in the execution of one or more processes 34. Other processes may be launched automatically by the OS or by another executing process. Any of these processes may correspond to the foreground process 34*, which is launched at 49 in the illustrated method.

At 50 data derived from vision system 24 and/or listening system 26 is received in NUI system 22. In some embodiments, such data may take the form of a raw data stream—e.g., a video or depth video data stream. In other embodiments, the data may have been pre-processed to some degree within the vision system. At 52, the data received in the NUI system is further processed to detect various states or conditions that constitute user input to computer system 18, as further described below.

In some embodiments, NUI system 22 may analyze the depth data to distinguish human subjects from non-human subjects and background. Through appropriate depth-image processing, a given locus of a depth map may be recognized as belonging to a human subject (as opposed to some other thing, e.g., furniture, a wall covering, a cat). In a more particular embodiment, pixels that belong to a human subject are identified by sectioning off a portion of the depth data that exhibits above-threshold motion over a suitable time scale, and attempting to fit that section to a generalized geometric model of a human being. If a suitable fit can be achieved, then the pixels in that section are recognized as those of a human subject. In other embodiments, human subjects may be identified by contour alone, irrespective of motion.

In one, non-limiting example, each pixel of a depth map may be assigned a person index that identifies the pixel as belonging to a particular human subject or non-human element. As an example, pixels corresponding to a first human subject can be assigned a person index equal to one, pixels corresponding to a second human subject can be assigned a person index equal to two, and pixels that do not correspond to a human subject can be assigned a person index equal to zero. Person indices may be determined, assigned, and saved in any suitable manner.

After all the candidate human subjects are identified in the fields of view (FOVs) of each of the connected depth cameras, NUI system 22 may make the determination as to which human subject (or subjects) will provide user input to computer system 18—i.e., which will be identified as a user. In one embodiment, a human subject may be selected as a user based on proximity to display 14 or depth camera 40, and/or position in a field of view of a depth camera. More specifically, the user selected may be the human subject closest to the depth camera or nearest the center of the FOV of the depth camera. In some embodiments, the NUI system may also take into account the degree of translational motion of a human subject—e.g., motion of the centroid of the subject—in determining whether that subject will be selected as a user. For example, a subject that is moving across the FOV of the depth camera (moving at all, moving above a threshold speed, etc.) may be excluded from providing user input.

After one or more users are identified, NUI system 22 may begin to process posture information from such users. The posture information may be derived computationally from depth video acquired with depth camera 40. At this stage of execution, additional sensory input—e.g., image data from a color camera 42 or audio data from listening system 26—may be processed along with the posture information. Presently, an example mode of obtaining the posture information for a user will be described.

In one embodiment, NUI system 22 may be configured to analyze the pixels of a depth map that correspond to a user, in order to determine what part of the user's body each pixel represents. A variety of different body-part assignment techniques can be used to this end. In one example, each pixel of the depth map with an appropriate person index (vide supra) may be assigned a body-part index. The body-part index may include a discrete identifier, confidence value, and/or body-part probability distribution indicating the body part or parts to which that pixel is likely to correspond. Body-part indices may be determined, assigned, and saved in any suitable manner.

In one example, machine-learning may be used to assign each pixel a body-part index and/or body-part probability distribution. The machine-learning approach analyzes a user with reference to information learned from a previously trained collection of known poses. During a supervised training phase, for example, a variety of human subjects may be observed in a variety of poses; trainers provide ground truth annotations labeling various machine-learning classifiers in the observed data. The observed data and annotations are then used to generate one or more machine-learned algorithms that map inputs (e.g., observation data from a depth camera) to desired outputs (e.g., body-part indices for relevant pixels).

In some embodiments, a virtual skeleton is fit to the pixels of depth data that correspond to a user. FIG. 4 shows an example virtual skeleton 54 in one embodiment. The virtual skeleton includes a plurality of skeletal segments 56 pivotally coupled at a plurality of joints 58. In some embodiments, a body-part designation may be assigned to each skeletal segment and/or each joint. In FIG. 4, the body-part designation of each skeletal segment 56 is represented by an appended letter: A for the head, B for the clavicle, C for the upper arm, D for the forearm, E for the hand, F for the torso, G for the pelvis, H for the thigh, J for the lower leg, and K for the foot. Likewise, a body-part designation of each joint 58 is represented by an appended letter: A for the neck, B for the shoulder, C for the elbow, D for the wrist, E for the lower back, F for the hip, G for the knee, and H for the ankle. Naturally, the arrangement of skeletal segments and joints shown in FIG. 4 is in no way limiting. A virtual skeleton consistent with this disclosure may include virtually any type and number of skeletal segments and joints.

In one embodiment, each joint may be assigned various parameters—e.g., Cartesian coordinates specifying joint position, angles specifying joint rotation, and additional parameters specifying a conformation of the corresponding body part (hand open, hand closed, etc.). The virtual skeleton may take the form of a data structure including any, some, or all of these parameters for each joint. In this manner, the metrical data defining the virtual skeleton—its size, shape, and position and orientation relative to the depth camera may be assigned to the joints.

Via any suitable minimization approach, the lengths of the skeletal segments and the positions and rotational angles of the joints may be adjusted for agreement with the various contours of the depth map. This process may define the location and posture of the imaged user. Some skeletal-fitting algorithms may use the depth data in combination with other information, such as color-image data and/or kinetic data indicating how one locus of pixels moves with respect to another. As noted above, body-part indices may be assigned in advance of the minimization. The body-part indices may be used to seed, inform, or bias the fitting procedure to increase the rate of convergence. For example, if a given locus of pixels is designated as the head of the user, then the fitting procedure may seek to fit to that locus a skeletal segment pivotally coupled to a single joint—viz., the neck. If the locus is designated as a forearm, then the fitting procedure may seek to fit a skeletal segment coupled to two joints—one at each end of the segment. Furthermore, if it is determined that a given locus is unlikely to correspond to any body part of the user, then that locus may be masked or otherwise eliminated from subsequent skeletal fitting. In some embodiments, a virtual skeleton may be fit to each of a sequence of frames of depth video. By analyzing positional change in the various skeletal joints and/or segments, the corresponding movements—e.g., gestures, actions, behavior patterns—of the imaged user may be determined.

The foregoing description should not be construed to limit the range of approaches that may be used to construct a virtual skeleton, for a virtual skeleton may be derived from a depth map in any suitable manner without departing from the scope of this disclosure. Moreover, despite the advantages of using a virtual skeleton to model a human subject, this aspect is by no means necessary. In lieu of a virtual skeleton, raw point-cloud data may be used directly to provide suitable posture information.

Returning now to FIG. 3, various actions may be taken downstream of the receipt and processing of data in NUI system 22. In some examples, the processed data may be analyzed until an engagement gesture or spoken engagement phrase from a user is detected. After an engaged user has been identified, processing of the data may continue, with various gestures of the engaged user being deciphered in order to provide input to computer system 18.

At 49, for example, a foreground process of the computer system is launched from OS shell 30 pursuant to detection of the appropriate NUI from the user. In some examples, the user may employ an air gesture to launch the foreground process. In other words, the user may enact a contactless gesture whereby the foreground process is selected from among a plurality of processes selectable from the OS shell. In response, the NUI may command the OS shell to activate the foreground process selected by way of the gesture.

The data received and processed in the NUI system will typically include data tracking a change in conformation of the user. As the user's gestures may include air gestures generally, and hand gestures specifically, the change in conformation tracked by the data may include at least a hand trajectory of the user. In more particular embodiments, the conformation may also include a grip state of the user. ‘Hand trajectory’ refers herein to time-resolved coordinates of the hand—e.g., coordinates one or more joints of the hand as determined from virtual skeleton 54 described above. The hand trajectory may specify, in some examples, coordinates of both hands, or it may specify the coordinates of only one hand. ‘Grip state’ refers to a measure of the relative openness of the hand. In some examples, the grip state may be defined by a Boolean value—viz., open or closed. More generally, the data processing enacted at 52 may include computation of any gestural metrics used as input in the illustrated methods. Such metrics may include hand trajectory and grip state, but may also include more particular metrics such as the magnitude and direction of a change in separation between the user's hands.

The gestures deciphered at 52 may include gestures to launch a process, change a setting of the OS, shift input focus from one process to another, or provide virtually any form of input to computer system 18. More particularly, this disclosure embraces various approaches to elicit and act upon in-zooming and out-zooming air gestures which a user may provide as input to the computer system.

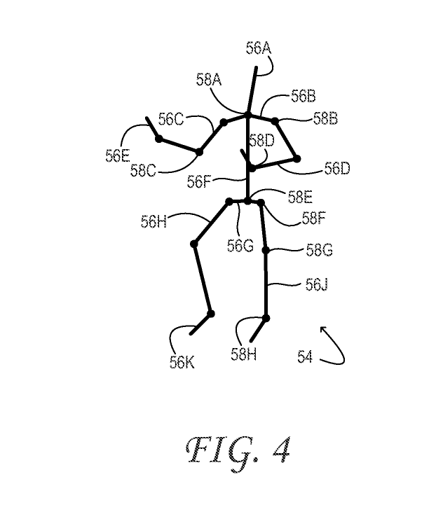

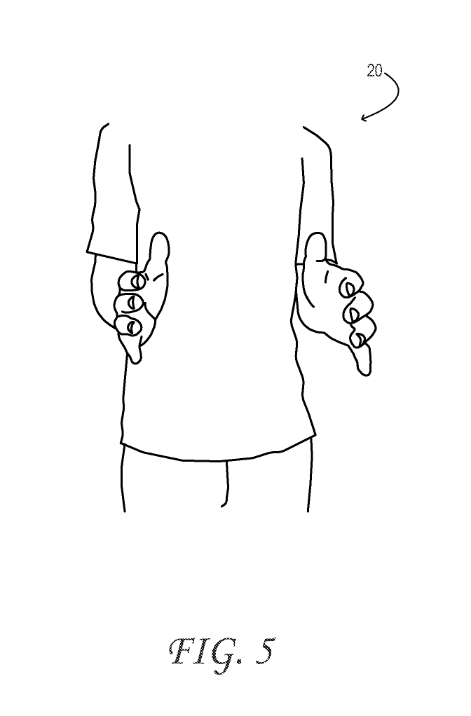

Continuing in FIG. 3, at 62 it is determined, based on the data received, whether the user's two hands are presented in front of the user. Such a posture is shown by example in FIG. 5. If the data show that both hands of the user are presented in front of the user, then the method advances to 64. However, if both hands are not presented in front of the user, then the method returns to 50, where additional data is received and processed. In some embodiments, the condition tested at 62 may include additional restrictions. For example, a positive indication that the hands are presented in front of the user may further require that the hands are presented in roughly the same plane (parallel to the plane of the display or normal to the optical axis of the vision system) or that both hands present the same grip state—i.e., both open or both closed.

At 64 a first visual guide is shown on the display. The first visual guide may include an image, graphic, icon, or animated image. It may be configured and positioned to indicate that the user is in a valid starting position to provide in-zooming or out-zooming input. The first visual guide may be further configured to suggest a manner of completing the air gesture that executes the in-zooming or out-zooming input. For example, the first visual guide may be configured to coax the user to air grab display 14. In addition to suggesting the manner of completing the air gesture, the first visual guide may serve another purpose, which is to alert the user that he or she has taken the initial step of executing a gesture that will result in zooming the display. Thus, the user who does not want to zoom the display has as opportunity to change his or her hand presentation to avoid zooming the display. In one embodiment, the first visual guide includes emphasis of the left and right boundaries of the display window in which the foreground process is represented. Such emphasis may take the form of display sidebars, for example. In this and other embodiments, the first visual guide may include an animated icon to suggest hand closure.

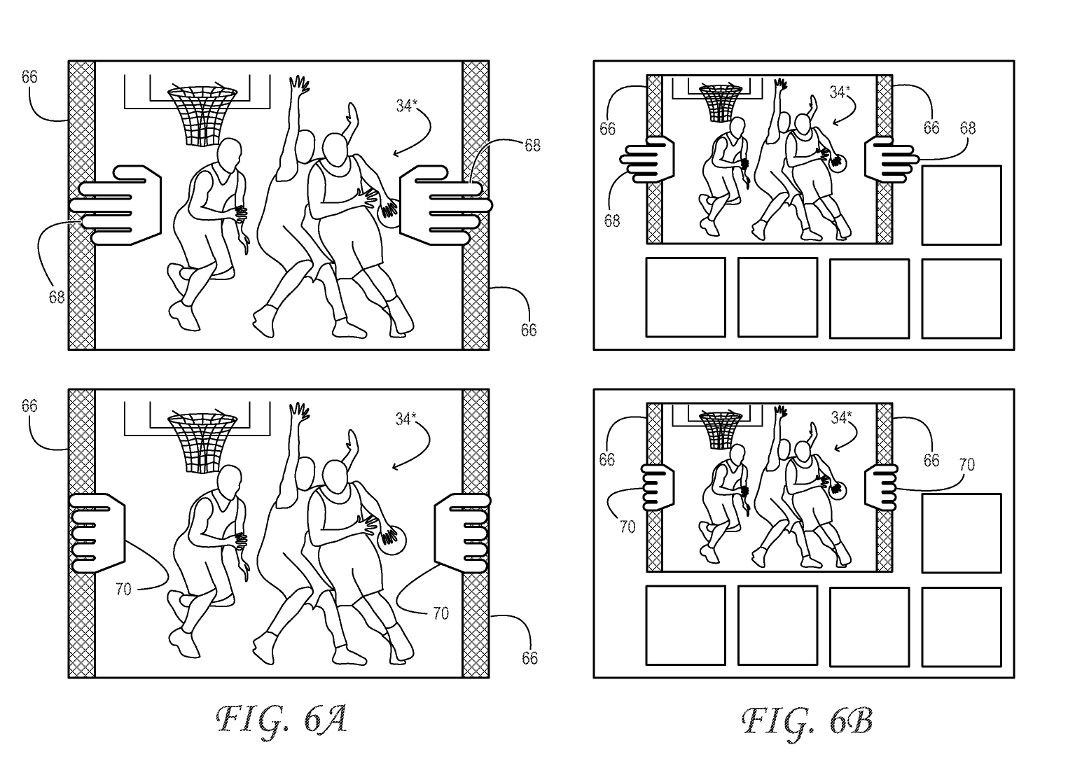

FIG. 6A illustrates two example display frames of display 14, which may appear when a first visual guide is being shown. In this example, the first visual guide includes shaded display sidebars 66. The first visual guide also includes an open-hand icon 68, as shown in the display frame of the upper part of the figure. After a predetermined interval, the open-hand disappears and is replaced by closed-hand icon 70, which is shown in the lower part of the figure. The first visual guide of FIG. 6A would be appropriate, for example, when foreground process 34* is being displayed full-screen, and the user may want to reduce it to a less than full-screen window. FIG. 6B illustrates analogous display frames that would be appropriate when the foreground process is already displayed in a window, and the user may want to view it full-screen.

At 72 it is determined, based on the data received, whether the user has dropped one or both hands after the hands have been presented in front of the user, but before any subsequent action of method 46. Accordingly, if the data show that the user's hands have dropped—are lowered, for example, and/or returned to the user's sides—then the method returns to 50, and the subsequent actions of method 46 are not enacted. If the hands are not dropped, however, then the method advances to 74.

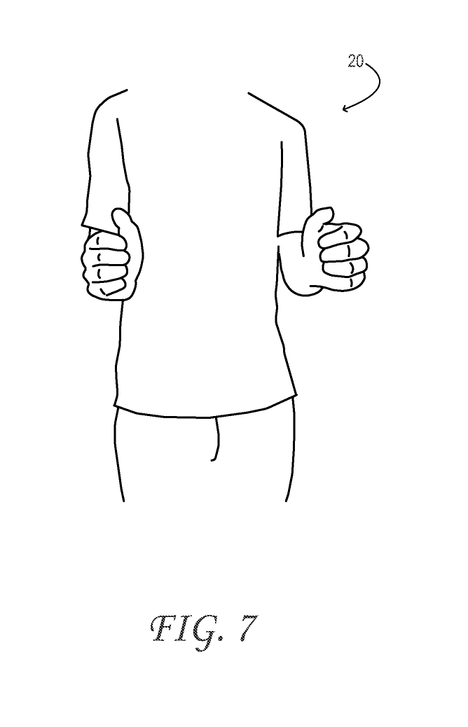

At 74 it is determined, based on the data received, whether the user closes one or both hands. Such a posture is shown by example in FIG. 7. If the data show hand closure by the user, then the method advances to 76. However, if sufficient evidence of hand closure is not discovered at 74, then the method returns to 50, effectively cancelling any zoom input that would have been initiated. In this way, the in-zooming and out-zooming inputs are provided only if the data show hand closure prior to, and in addition to, the conditions described further below.

At 76 a second visual guide is shown on display 14. The second visual guide may be configured to indicate that the user's air grab of the display has been understood by the NUI system. The second visual guide may be intended to coax the user to complete the zoom gesture already initiated—e.g., to stretch or compress the display by changing the separation of his or her hands. To this end, the second visual guide may include an image, graphic, icon, or animated image to suggest resize of the display window in which the foreground process is represented. In a more particular embodiment, the second visual guide may include a deformation of the left and right boundaries of the display window in which the foreground process is represented. Like the first visual guide, the second visual guide also alerts the user that he or she is on the path to zooming the display. Thus, the user who does not want to zoom the display has as opportunity to change her hand presentation or open her grip to avoid zooming the display.

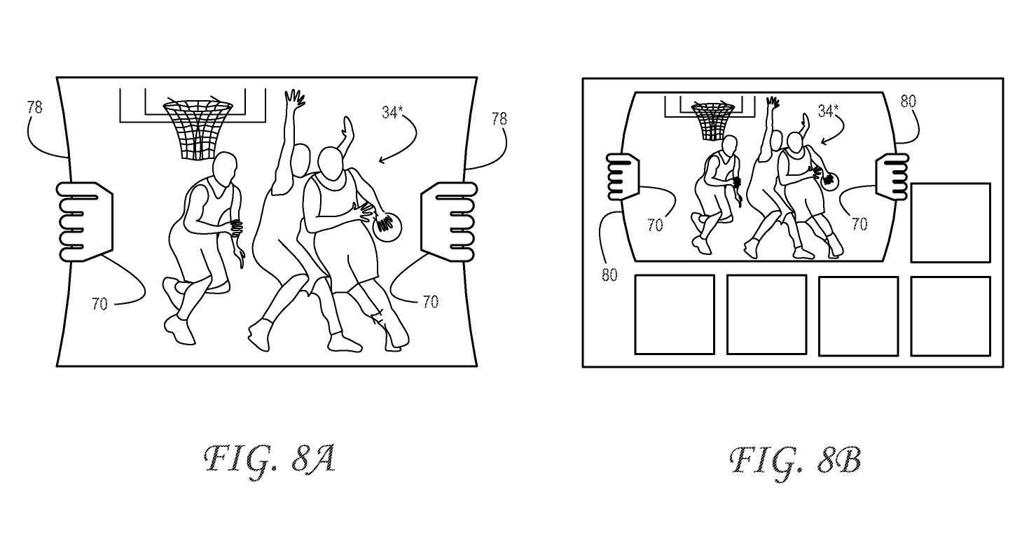

FIG. 8A illustrates an example display frame of display 14, which may appear when a second visual guide is being shown. In this example, the second visual guide includes concave deformation 78 of the left and right boundaries of the display, where foreground process 34* is displayed full-screen. The first visual guide also includes closed-hand icon 70. The second visual guide of FIG. 8A would be appropriate, for example, when foreground process 34* is already being displayed full-screen, and the user may want to reduce it to a less than full-screen window. FIG. 8B illustrates an analogous display frame that would be appropriate when the foreground process is already displayed in a window, and the user may want to view it full-screen. In addition to closed-hand icon 70, this frame shows convex deformation 80 of the left and right boundaries of the display window in which the foreground process is displayed.

At 82 of method 46, the user is given another opportunity to cancel the initiated zoom input. Here it is determined whether the data received show evidence of hand opening or hand dropping prior to execution of the subsequent steps of the method. If the data show that the user's hands have been opened or dropped, execution then returns to 50. Thus the in-zooming and out-zooming inputs may be cancelled if the data show hand opening after the hand closure, but before the zoom gesture is completed. If no such indication is shown in the data, then the method advances to 84.

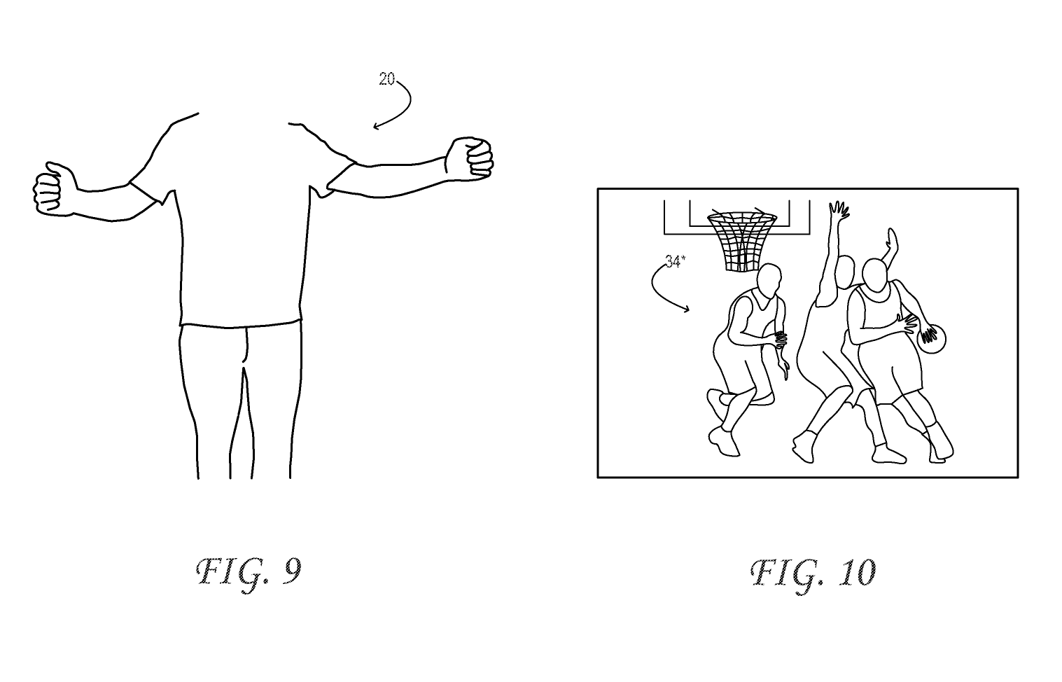

At 84 it is determined, based on the data received, whether the user is increasing the separation of his or her hands. Such a gesture is shown by example in FIG. 9. If the data show increasing separation between the user's two hands, then the method advances to 86, where in-zooming input is provided from NUI system 22 to computer system 18. In some embodiments, the in-zooming input may be provided to an OS of the computer system. For example, increasing separation between the user's two hands may have the effect of hiding the OS shell and causing foreground process 34* to be displayed full-screen on display 14. This result is shown in FIG. 10. Accordingly, the in-zooming input may be such as to cause a foreground process of the computer system to be displayed in greater detail on the display. More specifically, the foreground process may be expanded in size, resolution, or content. The in-zooming input may have this effect even on a foreground process not currently visible on the display. In one embodiment, the in-zooming input may take a process currently displayed as a tile, icon, small image, or static image, and cause it to be displayed as a larger, animated, and/or live image.

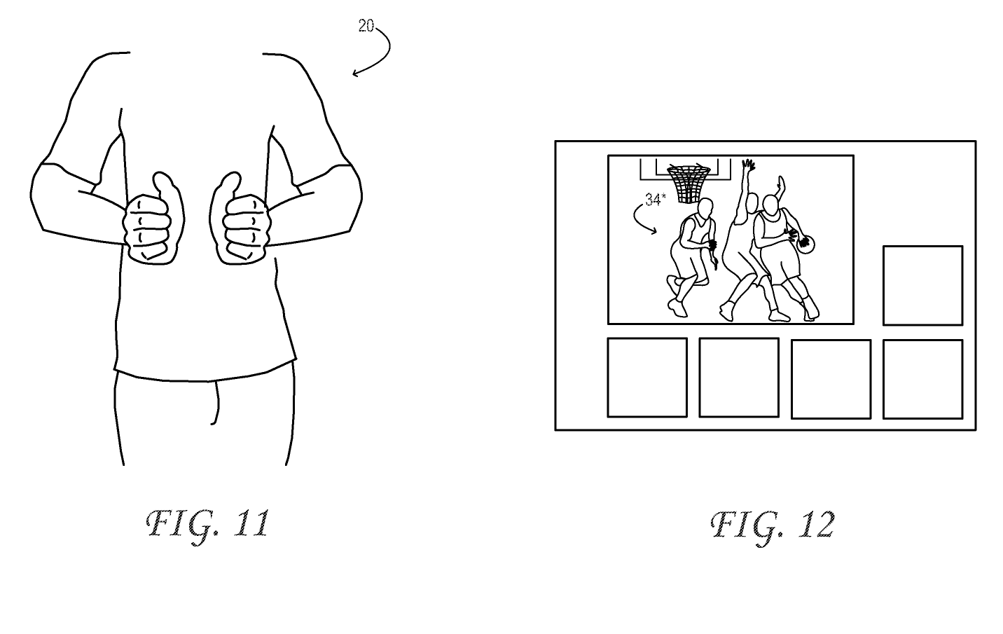

At 88 it is determined, based on the data received, whether the user is decreasing the separation of his or her hands. Such a gesture is shown by example in FIG. 11. If the data show decreasing separation between the user's two hands, then the method advances to 90, where out-zooming input is provided from NUI system 22 to computer system 18. In some embodiments, the out-zooming input is provided to an OS of the computer system. The out-zooming input may be such as to cause the foreground process currently displayed on display 14 to be represented in lesser detail. For instance, the out-zooming input may cause a process currently displayed as a live, full-screen image, or as live video, or as text, to be displayed at reduced size or resolution, collapsed, or confined to a window or icon. This result is shown in FIG. 12. In some embodiments, the out-zooming input may effectively remove the foreground process from display.

In these and other embodiments, the in-zooming input may cause the foreground process to be displayed on a larger scale, and the out-zooming input may cause the foreground process to be displayed on a smaller scale. The foreground process may be displayed on a scale based quantitatively on an amount of increase or decrease in the separation in some examples, providing, effectively, a free-form analog zoom function. In embodiments in which the computer system is configured to execute an OS shell from which the foreground process is selected, the out-zooming input may expose a portion of the OS shell on the display and cause the foreground process to be displayed in a window. Conversely, the in-zooming input may hide the OS shell and cause the foreground process formerly displayed in a window to be displayed full-screen on the display. In some embodiments, the foreground process may continue to run while displayed in the window. This window may be reserved for a recently de-emphasized but still-active processes. In some scenarios, the action of windowing the foreground process may constitute a half step back towards ending the process.

As noted above, the in-zooming and out-zooming inputs may be provided only if the data show that both hands are presented in front of the user and then closed prior to the increasing or decreasing separation. Furthermore, the in-zooming and out-zooming inputs may be provided only if the separation changes by more than a threshold amount—e.g., more than five inches, more than twenty percent of the initial separation, etc.

It will be noted that the multi-step nature of the in-zooming and out-zooming inputs, in addition to the plural cancellation opportunities afforded the user, give the method a reversible, analog feel. In essence, the in-zooming and out-zooming inputs can be advanced into and backed out of in a series of smooth, reversible steps, rather than instantaneous, irreversible events.

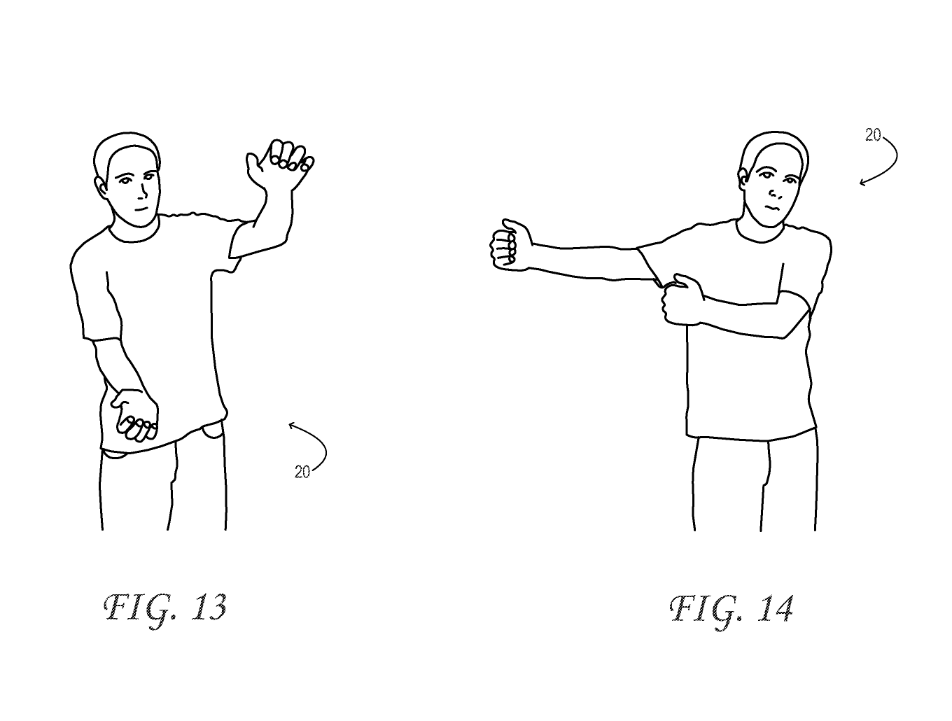

Continuing in FIG. 3, at 92 it is determined, based on the data received, whether the user is enacting a two-handed sweep or rotation gesture while continuing the air grab. FIG. 13 shows an example of a two-handed rotation gesture; FIG. 14 shows an example of a two-handed sweep gesture. If the data show a two-handed sweep or rotation gesture after presentation of the hands in front of the user, followed by closure of the hands and subject to the other conditions of method 46, then the method advances to 94, where alternative input is provided to the computer system. In one embodiment, such alternative input may expose a different portion or page of the OS shell. In this manner, the alternative input may enable a range of different processes to be selectable from the OS shell.

In one embodiment, a sweep gesture in one direction could be used to hide a window that is currently on-screen and move it off-screen. A sweep gesture in the opposite direction could be used to restore to the display screen a process that is currently off-screen. The sweep gesture could also be used to initiate a system UI that would animate in and out from the side—akin to a ‘charms’ UI on Windows 8 (product of Microsoft Corporation of Redmond, Wash.), for example. A rotate gesture could be used for intuitive photo manipulation, as one example.

In still other examples, the alternative input may be signaled not by a two-handed sweep or rotation gesture, but by a further increase or further decrease in the separation of the user's hands. For instance, bringing the hands quite close together (e.g., barely separated or clasped) may cause additional zooming out, to expose a different portion of the OS shell. In other words, the out-zooming input described previously may expose a first portion of the OS shell on the display, and the alternative input may expose a second portion of the OS shell. This further out-zooming may cause the foreground process already displayed in a window to be further de-emphasized—e.g., de-emphasized down to a tile or icon. Likewise, further in-zooming (e.g., to an exaggerated open-arm gesture) may expose detailed display settings of a foreground process already displayed full-screen, or may have some other effect.

No aspect of the foregoing example should be understood in a limiting sense, for numerous extensions, variations, and partial implementations are contemplated as well. In some embodiments, for example, the OS of the computer system may be configured to spontaneously shift the input focus from the current foreground process to another process. This may be done to issue a notification to the user. Once the input focus has been shifted, the user's in-zooming and out-zooming inputs would apply to the new process. For instance, the user may zoom in to receive more detailed information about the subject of the notification, or zoom out to dismiss the notification. In some embodiments, once the notification has been out-zoomed, input focus may be given back to the process that released it to display the notification.

As evident from the foregoing description, the methods and processes described herein may be tied to a computing system of one or more computing devices. Such methods and processes may be implemented as a computer-application program or service, an application-programming interface (API), a library, and/or other computer-program product.

Shown in FIG. 2 in simplified form, NUI system 22 is a non-limiting example of a computing system that can enact one or more of the methods and processes described herein. As noted hereinabove, the NUI system includes a logic machine 36 and an instruction-storage machine 38. NUI system 22, or computer system 18, which receives user input from the NUI system, may optionally include a display 14, a communication system 96, and/or other components not shown in FIG. 2.

Logic machine 36 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic machine 36 may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Instruction-storage machine 38 includes one or more physical devices configured to hold instructions executable by logic machine 36 to implement the methods and processes described herein. When such methods and processes are implemented, the state of the instruction-storage machine may be transformed—e.g., to hold different data. The instruction-storage machine may include removable and/or built-in devices; it may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The instruction-storage machine may include volatile, nonvolatile, dynamic, static, read/write, read-only, random-access, sequential-access, location-addressable, file-addressable, and/or content-addressable devices.

It will be appreciated that instruction-storage machine 38 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 36 and instruction-storage machine 38 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms ‘module,’ ‘program,’ and ‘engine’ may be used to describe an aspect of computing system 98 implemented to perform a particular function. In some cases, a module, program, or engine may be instantiated via logic machine 36 executing instructions held by instruction-storage machine 38. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms ‘module,’ ‘program,’ and ‘engine’ may encompass individual or groups of executable files, data files, libraries, drivers, scripts, database records, etc.

It will be appreciated that a ‘service’, as used herein, is an application program executable across multiple user sessions. A service may be available to one or more system components, programs, and/or other services. In some implementations, a service may run on one or more server-computing devices.

When included, communication system 96 may be configured to communicatively couple NUI system 22 or computer system 18 with one or more other computing devices. The communication system may include wired and/or wireless communication devices compatible with one or more different communication protocols. As non-limiting examples, the communication system may be configured for communication via a wireless telephone network, or a wired or wireless local- or wide-area network. In some embodiments, the communication system may allow NUI system 22 or computer system 18 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. In a computer system with a display, a natural user input (NUI) system for mediating input from a user, the NUI system comprising a logic machine and an instruction storage machine holding instructions that, when executed by the logic machine, cause the logic machine to:
receive data tracking a change in conformation of the user including at least a hand trajectory of the user, the data derived from depth video of the user;
if the data show increasing separation between two hands of the user, cause a foreground process of the computer system to be displayed in greater detail on the display; and
if the data show decreasing separation between the two hands of the user, cause the foreground process, displayed on the display, to be represented in lesser detail.

2. The NUI system of claim 1, wherein the foreground process is displayed in greater detail as a result of in-zooming input provided by the NUI system to an operating-system (OS) of the computer system, and wherein the foreground process is displayed in lesser detail as a result of out-zooming input provided by the NUI system to the OS.

3. The NUI system of claim 2, wherein the computer system is configured to execute an OS shell from which the foreground process is selected, wherein the out-zooming input exposes a portion of the OS shell on the display, and wherein the in-zooming input hides the OS shell and causes the foreground process to be displayed full-screen on the display.

4. The NUI system of claim 2, wherein the in-zooming and out-zooming inputs are provided only if the data show hand closure prior to the increasing or decreasing separation.

5. The NUI system of claim 4, wherein the in-zooming and out-zooming inputs are cancelled if the data show hand opening after the hand closure but before the increasing or decreasing separation.

6. The NUI system of claim 2, wherein the in-zooming and out-zooming inputs are provided only if the data show that both hands are presented in front of the user prior to the increasing or decreasing separation.

7. The NUI system of claim 4, wherein the in-zooming and out-zooming inputs are cancelled if the data show hand dropping after the hands are presented in front of the user but before the increasing or decreasing separation.

8. The NUI system of claim 2, wherein the in-zooming and out-zooming inputs are provided only if the separation changes by more than a threshold amount.

9. The NUI system of claim 2, wherein the in-zooming input causes the foreground process to be displayed on a larger scale, and wherein the out-zooming input causes the foreground process to be displayed on a smaller scale.

10. The NUI system of claim 2, wherein the instructions cause the logic machine to provide alternative input if the data show presentation of the hands in front of the user, followed by closure of the hands, followed by a two-handed sweep or rotation gesture.

11. The NUI system of claim 10, wherein the computer system is configured to execute an operating-system (OS) shell from which the foreground process is selected, and wherein the alternative input enables a different foreground process selectable from the OS shell to become the foreground process.

12. The NUI system of claim 10, wherein the computer system is configured to execute an operating-system (OS) shell from which the foreground process is selected, wherein the out-zooming input exposes a first portion of the OS shell on the display, and wherein the alternative input exposes a second portion of the OS shell on the display.

13. In a computer system with a display, a natural user input (NUI) system for mediating input from a user, the NUI system comprising a logic machine and an instruction storage machine holding instructions that, when executed by the logic machine, cause the logic machine to:
receive data tracking a change in conformation of the user including at least a hand trajectory and grip state of the user, the data derived from depth video of the user;
if the data show that both hands of the user are presented in front of the user, cause a first visual guide to be shown on the display;
if the data show hand closure of the user, cause a second visual guide to be shown on the display;
if the data show increasing separation between two hands of the user following the presentation of both hands and hand closure, cause a foreground process of the computer system to be displayed in greater detail on the display; and
if the data show decreasing separation between the two hands of the user following the presentation of both hands and hand closure, cause the foreground process to be represented in lesser detail.

14. The NUI system of claim 13, wherein the first visual guide includes emphasis of left and right boundaries of a display window in which the foreground process is represented.

15. The NUI system of claim 13, wherein the first visual guide includes an animated icon to suggest hand closure.

16. The NUI system of claim 13, wherein the second visual guide includes an animated icon to suggest resize of a display window in which the foreground process is represented.

17. The NUI system of claim 13, wherein the second visual guide includes a deformation of left and right boundaries of a display window in which the foreground process is represented.

18. A computer system comprising a logic machine and an instruction storage machine holding instructions that, when executed by the logic machine, cause the logic machine to:
execute an operating-system (OS) shell from which a foreground process is selectable;
receive, in a natural user-input (NUI) system, data tracking a change in conformation of a user including at least a hand trajectory of the user, the data derived from depth video of the user;
if the data show increasing separation between two hands of the user, hide the OS shell and cause the foreground process to be displayed full-screen on a display operatively coupled to the computer system; and
if the data show decreasing separation between the two hands of the user, expose a portion of the OS shell on the display and cause the foreground process to be displayed in a window.

19. The computer system of claim 18, wherein the data shows, prior to the increasing separation, a contactless gesture of the user whereby the foreground process is selected from among a plurality of foreground processes selectable from the OS shell, and wherein the instructions cause the logic machine to activate the foreground process selected by the gesture.

20. The computer system of claim 18, wherein a further decrease in the separation, if shown in the data, exposes a greater portion of the OS shell on the display and causes the foreground process displayed in the window to be further de-emphasized.
